(19) United States
(12) Patent Application Publication
(10) Pub. No.: US 2008/0121743 A1
(43) Pub. Date: May 29, 2008

(54) System For Pneumatically Conveying Particulate Material

(76) Inventors: Eric T. Fleckten, Kirkville, NY (US); David M. Gerber, East Syracuse, NY (US); Stephen C. Palin, Jamesville, NY (US); Vernon R. Hudalla, Charlotte, NC (US); Jerry C. VanDerWerff, East Bethel, MN (US)

Correspondence Address: PATENT GROUP 2N;JONES DAY, NORTH POINT, 901 LAKESIDE AVENUE, CLEVELAND, OH, 44114, US

(21) Appl. No.: 11/829,433

(22) Filed: Jul. 27, 2007

Related U.S. Application Data
(60) Provisional application No. 60/861,637, filed on Nov. 29, 2006.

(51) Int. Cl. B02C 23/26

(52) U.S. Cl. 241/47

(57) ABSTRACT

An apparatus for pneumatically conveying particulate material to an application site includes a mill that is operative to reduce the particle size of the material. The mill has a specified air flow capacity. The apparatus further includes a container for the particulate material, an air lock that discharges the particulate material from the containers and a blower. The blower has a specified air flow output greater than the air flow capacity of the mill.

### RELATED APPLICATIONS

This application claims the benefit of provisional U.S. Patent Application 60/861,637, filed Nov. 29, 2006, which is incorporated by reference.

### TECHNICAL FIELD

This technology relates to a system for pneumatically conveying particulate material from a storage container to a site at which the material is used.

### BACKGROUND

Exhaust gases may include compounds that can be reduced by applying reactant material prior to emitting the exhaust gases into the atmosphere. A system for applying the reactant material to the exhaust gases includes a blower for pneumatically conveying the material to the application site. The reactant material may be applied in particulate form, and may originally have a particle size that is not optimal for application to the exhaust gases. If so, the material may be milled to reduce the particle size before it is applied to the exhaust gases.

### SUMMARY

An apparatus for pneumatically conveying particulate material from a container to an application site includes a mill for reducing the particle size of the material. The apparatus further includes a blower with a maximum air flow output that is greater than the specified air flow capacity of the mill. The blower is pneumatically interconnected with the container, the mill, and the application site for the air flow output of the blower to drive a first stream of material-free air from the blower to the container, a second stream of material-laden air from the container to the mill, and a third stream of material-laden air from the mill to the application site. Other parts of the apparatus function to maintain the air flow in the second flow path equal to or substantially equal to the specified air flow capacity of the mill. Those parts preferably include means for determining the amount that the actual blower output exceeds the specified air flow capacity of the mill, and means for diverting that amount of the blower output from the first stream to the third stream along a flow path that bypasses the mill.

Summarized differently, the apparatus includes a first source of pressurized air and a pneumatic conveyance line configured to convey the particulate material in a stream of air from the first source. A plurality of injection lances branch from the pneumatic line and terminate at the application site. A plug clearance system for the injection lances includes a subsystem at each injection lance. Each subsystem includes a sensor that is operative to sense pneumatic pressure in the respective lance, a first valve that is operative to block the flow of material-laden air from the conveyance line through the lance, and a second valve that is operative to direct material-free air from a second source into the lance to clear a plug of material from the lance.

### BRIEF DESCRIPTION OF THE DRAWINGS

FIG. 1 is a schematic view showing parts of a system for conveying the particulate material pneumatically from a container to an application site.

FIG. 2 is a schematic view showing other parts of the system of FIG. 1.

FIG. 3 also is a schematic view showing other parts of the system of FIG. 1.

### DETAILED DESCRIPTION

The apparatus shown in the drawings has parts that are examples of the elements recited in the claims. The following description thus includes examples of how a person of ordinary skill in the art can make and use the claimed invention. It is presented here to meet the statutory requirements of written description, enablement, and best mode without imposing limitations that are not recited in the claims.

FIG. 1 shows parts of a system 10 for pneumatically conveying particulate material to a site 12 at which the material is to be applied. The system 10 includes a container 14 with a stored quantity of the material 16. The container 14 in the illustrated example is a weigh hopper with a rotary air lock 18. The material 16 is a sorbent for reducing emissions of exhaust compounds such as sulfur dioxide, sulfur trioxide, nitrogen oxide, mercury, and hydrochloric acid. Accordingly, the application site 12 in the illustrated example is ductwork for conveying flue gas to the exhaust stack in a plant that produces such exhaust compounds.

Other parts of the system 10 include a blower 20, a mill 22, and pneumatic lines that interconnect the blower 20 and the mill 22 with the container 14 and the ductwork 12. A blower output line 30 defines a flow path extending from the blower 20 to the air lock 18. A material conveyance line 32 defines a flow path extending from the air lock 18 to the mill 22, and further defines a flow path extending onward from the mill 22 toward the ductwork 12. A bypass line 34 extends from a juncture 36 with the blower output line 30 to a juncture 38 with the conveyance line 32. The first juncture 36 is located upstream of the air lock 18. The second juncture 38 is located downstream of the mill 22. The bypass line 34 thus defines a flow path that bypasses the air lock 18 and the mill 22 between the blower 20 and the ductwork 12.

In operation of the system 10, a stream of material-free air is conveyed from the blower 20 to the air lock 18 along the blower output line 30. The air lock 18 operates to discharge particulate material 16 into the blower output line 30 while isolating the weigh hopper 14 from the elevated pneumatic pressure in the blower output line 30. A stream of material-laden air is then conveyed along the blower output line 30 downstream from the air lock 18. That stream of material-laden air flows into and through the mill 22 for a reduction in the particle size of the material. The milled material is then conveyed further downstream from the mill 22 toward the ductwork 12 along the conveyance line 32.

The maximum air flow output of the blower 20 is great enough to convey the milled material through the entire length of the conveyance line 32. As a result, the actual air flow output of the blower 20 is likely to be greater than the specified air flow capacity of the mill 22 at any particular time during operation of the system 10. Therefore, as the blower output line 30 carries the output of the blower 20 downstream toward the first juncture 36, a sensor 40 in that line 30 indicates the extent to which the actual blower output exceeds the specified air flow capacity of the mill 22. An assembly of valves 42 is operative to divert the excess air flow from the blower output line 30 to the bypass line 34. This avoids exceeding the air flow capacity of the mill 22, yet enables the material-laden air stream emerging from the mill 22 to be conveyed downstream from the second juncture 38 to the ductwork 12 under the influence of an air flow that is greater than the capacity of the mill 22.

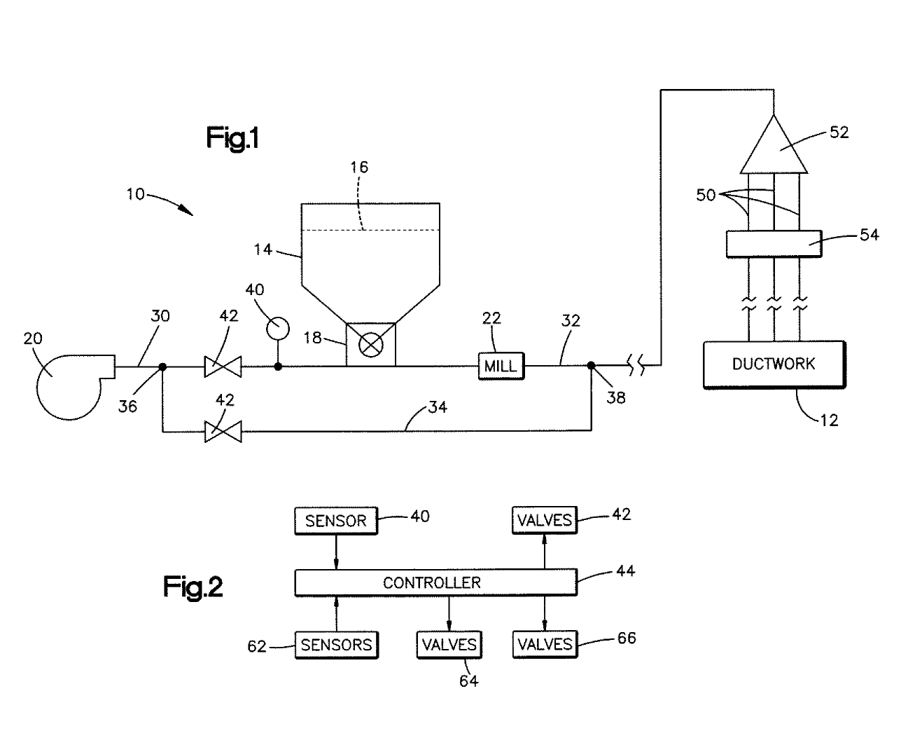

Preferably, the sensor 40 is a flow meter that is operative in the blower output line 30 to generate a signal indicating the air flow into the air lock 18, as shown in FIG. 1. A controller 44 (FIG. 2) is configured to compare the indicated air flow with a predetermined value representing the specified air flow capacity of the mill 22. The controller 44 is further configured to operate the valves 42 with reference to that comparison so as to maintain the air flow into the mill 22 equal to or substantially equal to the specified capacity.

The system 10 also includes a plurality of injection lances 50 for injecting the material-laden air stream from the conveyance line 32 into the ductwork 12. The injection lances 50, three of which are shown schematically in the drawings, branch outward from a splitter 52 at the end of the conveyance line 32. Since the lances 50 are relatively constricted as compared with the conveyance line 32, a plug clearance system 54 is provided to remove plugs of the particulate material 16 from the lances 50 as needed.

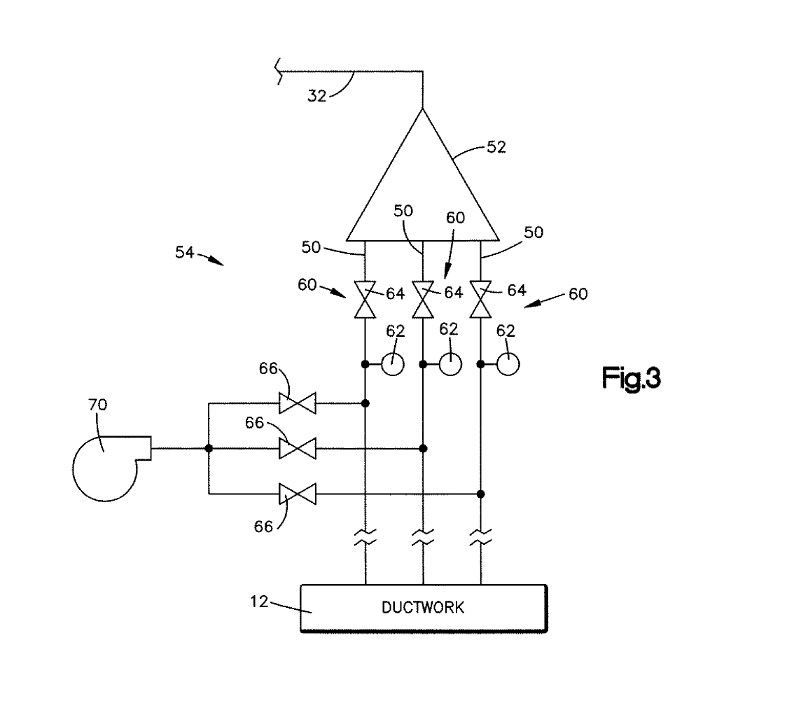

As shown in FIG. 3, the plug clearance system 54 includes a plurality of subsystems 60, each of which is associated with a respective one of the lances 50. Each subsystem 60 includes a sensor 62 and a pair of valves 64 and 66. The sensor 62 in each subsystem 60 is operative to sense pneumatic pressure in the respective lance 50. The first valve 64 is operative to block the flow of material-laden air from the conveyance line 32 through the lance 50. The second valve 66 is operative to direct a pressurized stream of material-free air from a source 70 into the lance 50. The source 70 is separate from the blower 20, and preferably comprises a plant air system at the plant where the ductwork 12 is located. When the sensor 62 in a plug clearance subsystem 60 indicates the presence of a plug of the particulate material in the respective lance 50, the controller 44 (FIG. 2) responds by directing the first valve 64 to shift to a closed condition to isolate the downstream length of the lance 50 from the pneumatic pressure and particulate material in the conveyance line 32. The controller 44 also directs the second valve 66 to shift to an open condition to direct a pressurized stream of material-free air into that section of the lance 50 to clear the plug. When the sensor 62 indicates that the plug has been cleared, the controller 44 shifts the valves 64 and 66 back to their original conditions.

The patentable scope of the invention is defined by the claims, and may include other examples of how the invention can be made and used. Such other examples, which may be available either before or after the application filing date, are intended to be within the scope of the claims if they have structural elements that do not differ from the literal language of the claims, or if they have equivalent structural elements with insubstantial differences from the literal language of the claims.

What is claimed is:

1. An apparatus for pneumatically conveying particulate material from a container to an application site, comprising:
a mill that is operative to reduce the particle size of the material, the mill having a specified air flow capacity;
a blower having a maximum air flow output greater than the specified air flow capacity of the mill;
means for pneumatically interconnecting the blower with the container, the mill, and the application site for the air flow output of the blower to drive a first stream of material-free air from the blower to the container, a second stream of material-laden air from the container to the mill, and a third stream of material-laden air from the mill to the application site; and
means for maintaining the air flow in the second flow path equal to or substantially equal to the specified air flow capacity of the mill.

2. An apparatus as defined in claim 1 wherein the maintaining means includes means for determining the amount that the actual blower output exceeds the specified air flow capacity of the mill, and means for diverting that amount of the blower output from the first stream to the third stream along a flow path that bypasses the mill.

3. An apparatus for pneumatically conveying particulate material to an application site, comprising:
a container for the particulate material;
an air lock operatively associated with the container to discharge the particulate material from the container;
a mill that is operative to reduce the particle size of the material, the mill having a specified air flow capacity;
a blower having a maximum air flow output greater than the air flow capacity of the mill; and
pneumatic lines configured to interconnect the blower, the air lock, and the mill along pneumatic flow paths including:
a) a first flow path to convey material-free air from the blower to the air lock;
b) a second flow path to convey material-laden air from the air lock to the mill;
c) a third flow path to convey material-laden air from the mill toward the application site; and
d) a fourth flow path to convey material-free air from the blower to the third flow path, whereby actual blower output in excess of the specified air flow capacity of the mill can be applied to convey milled material toward the application site.

4. An apparatus as defined in claim 3 further comprising a sensor that is operative in the first flow path to measure the actual blower output, a valve assembly that is operative to divert air flow from the first flow path to the fourth flow path, and a controller that is configured to determine the amount of actual blower output that exceeds the specified air flow capacity of the mill and to operate the valve assembly so as to regulate the air flow along the first and fourth flow paths with reference to the excess blower output.

5. An apparatus as defined in claim 4 wherein the controller is configured to operate the valve assembly so as to maintain the air flow in the second flow path equal to or substantially equal to the specified air flow capacity of the mill.

6. An apparatus for pneumatically conveying particulate material to an application site, comprising:
a first source of pressurized air;
a pneumatic conveyance line configured to convey the material in a stream of air from the first source;
a plurality of injection lances branching from the pneumatic line and terminating at the application site;
a second source of pressurized air separate from the first source; and
a plug clearance system including a subsystem at each injection lance, with each subsystem comprising a sensor that is operative to sense pneumatic pressure in the respective lance, a first valve that is operative to block the flow of material-laden air from the pneumatic conveyance line through the lance, and a second valve that is operative to direct material-free air from the second source into the lance, whereby the material-free air can clear a plug of material from the lance.

7. An apparatus as defined in claim 6 further comprising a controller configured to operate the valves with reference to the sensed pneumatic pressure.
